(19) United States
(12) Patent Application Publication
(10) Pub. No.: US 2009/0301120 A1
(43) Pub. Date: Dec. 10, 2009

(54) AIRCRAFT GALLEY REFRIGERATION SYSTEM INCLUDING A REDUCED WEIGHT AND DEPTH STORAGE COMPARTMENT COOLING APPARATUS

(75) Inventors: William Godecker, Irvine, CA (US); R. Bruce Thayer, San Juan Capistrano, CA (US); Mark Edward Wesley, San Diego, CA (US); Timothy Andrew Birkmann, Corona, CA (US); Patricia Gary, Anaheim, CA (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: B/E Aerospace, Inc., Wellington, FL (US)

(21) Appl. No.: 12/478,923

(22) Filed: Jun. 5, 2009

Related U.S. Application Data
(60) Provisional application No. 61/059,047, filed on Jun. 5, 2008.

(51) Int. Cl. B60H 1/32; F28D 5/00; F25D 17/06

(52) U.S. Cl. 62/239; 62/314; 62/419

(57) ABSTRACT

Embodiments of a storage compartment cooling apparatus include a liquid circulation system configured to circulate a liquid coolant having a temperature lower than an ambient temperature. The embodiments also include a centrifugal fan configured to cause a gas to flow in contact with the liquid circulation system and thereby cool the gas. The centrifugal fan is configured to receive the gas from a direction approximately parallel with an axis of rotation of the fan and output the gas to a direction approximately perpendicular with the axis of rotation of the fan. Embodiments of the apparatus also include a duct configured to direct the gas into contact with the liquid circulation system and through the centrifugal fan.

### CROSS-REFERENCE TO RELATED APPLICATION

This application claims the priority benefit of U.S. Provisional Patent Application Ser. No. 61/059,047 entitled “Aircraft Galley Refrigeration System Including Reduced-Weight Air Cooling Units, and Power Distribution Module Therefor” and filed on Jun. 5, 2008, which is hereby incorporated herein by reference.

### BACKGROUND

1. Field of the Invention

The present invention generally relates to refrigeration systems, and more particularly to aircraft galley refrigeration systems including a reduced weight and depth storage compartment cooling apparatus.

2. Related Art

Aircraft, especially commercial aircraft, typically include galleys equipped with galley refrigeration systems including storage cabinets for items requiring refrigeration, such as food and beverages. The galley refrigeration systems typically include galley refrigeration units, which may also be referred to as storage compartment cooling apparatuses (SCCA's). The SCCA's are typically used in galley or kitchen areas onboard an aircraft to keep items (e.g., food and beverages) cold. A typical SCCA includes a self-contained vapor cycle system configured to provide the cooling functionality of the SCCA. The vapor cycle system typically includes a compressor, condenser, heat exchanger, and power module. The power module is typically integral or unitary with the SCCA. The power module typically receives power from a power bus onboard the aircraft for energizing components of the vapor cycle system.

The SCCA's are typically configured as line replaceable units (LRU's). In aircraft systems, LRU's are self-contained units (e.g., “black boxes”) which may be quickly removed and replaced as a complete unit. By configuring the SCCA's as LRU's, the SCCA's may be easily replaced without extended removal of the aircraft from service or delays of scheduled flights. To facilitate quick and easy removal and replacement, the LRU's typically have a simple interface to other systems onboard the aircraft. For example, a typical SCCA's interface to other systems onboard the aircraft may simply be a connector to the power bus onboard the aircraft.

By being configured as an LRU, each SCCA is a self-contained unit and may operate independently, whether only one SCCA is installed or whether many SCCA's are installed onboard the aircraft. Therefore, components of the SCCA's which may, in principle, be shared, are instead duplicated. This duplication leads to additional weight and space utilization compared to having a single integrated SCCA providing the same functionality but without being configured as a collection of LRU's. Because multiple SCCA's are typically installed in each galley of an aircraft, many duplicate vapor cycle system components are installed as well. This duplication leads to increased weight and space utilization by the collection of installed SCCA's. Due to the relationships between fuel consumption, aircraft weight, maximum payload (e.g., passengers and luggage), and maximum travel distance, it is generally desirable to reduce the weight of components onboard the aircraft. Furthermore, due to the relationship between maximum passenger capacity and revenue generated per flight of the aircraft, it is generally desirable to maximize the space available for revenue generating passenger seats on commercial aircraft, for example by reducing the size (e.g., depth) of components onboard the aircraft.

### SUMMARY

In various embodiments, a storage compartment cooling apparatus includes a liquid circulation system configured to circulate a liquid coolant having a temperature lower than an ambient temperature. The apparatus may also include a centrifugal fan configured to cause a gas to flow in contact with the liquid circulation system and thereby cool the gas. The centrifugal fan may be configured to receive the gas from a direction approximately parallel with an axis of rotation of the fan and output the gas to a direction approximately perpendicular with the axis of rotation of the fan. The apparatus may also include a duct configured to direct the gas into contact with the liquid circulation system and through the centrifugal fan.

In various embodiments, a storage compartment cooling system includes a plurality of storage compartment cooling apparatuses. Each of the plurality of storage compartment cooling apparatuses may be coupled with a storage compartment and configured to cool an interior of the storage compartment. Each of the plurality of storage compartment cooling apparatuses may include a liquid circulation system configured to circulate a liquid coolant having a temperature lower than an ambient temperature. Each apparatus may also include a centrifugal fan configured to cause a gas to flow in contact with the liquid circulation system and thereby cool the gas. The centrifugal fan may be configured to receive the gas from a direction approximately parallel with an axis of rotation of the fan and output the gas to a direction approximately perpendicular with the axis of rotation of the fan. Each apparatus may also include a duct configured to direct the gas into contact with the liquid circulation system and through the centrifugal fan. The storage compartment cooling system may also include a central liquid coolant distribution system configured to circulate the liquid coolant to the plurality of storage compartment cooling apparatuses.

In various embodiments, a storage compartment cooling system includes a plurality of storage compartment cooling apparatuses. Each apparatus may be coupled with a storage compartment and configured to cool an interior of the storage compartment. Each of the apparatuses may include a liquid circulation system configured to circulate a liquid coolant having a temperature lower than an ambient temperature. Each apparatus may also include a fan configured to cause a gas to flow in contact with the liquid circulation system and thereby cool the gas. Each apparatus may further include a duct configured to direct the gas into contact with the liquid circulation system and through the centrifugal fan. The system may also include a power distribution module configured to receive power from a power bus, condition the power, and distribute the conditioned power to the plurality of storage compartment cooling apparatuses.

### BRIEF DESCRIPTION OF THE DRAWINGS

FIG. 1 illustrates a front view of an exemplary arrangement of galley trolleys in a lower portion of an aircraft galley.

FIG. 2 illustrates a side view of an exemplary refrigerated galley trolley including an SCCA installed at the rear of the galley trolley.

FIG. 3 illustrates an exemplary installation of an SCCA at a side of a galley trolley in a service column between galley trolleys.

FIG. 4 is a diagram of an exemplary SCCA installed at the rear of a galley trolley.

FIG. 5 illustrates an exemplary SCCA comprising a centrifugal fan.

FIG. 6 is a perspective view of components of an exemplary centrifugal fan.

FIG. 7 is a perspective view of the exemplary centrifugal fan of FIG. 6 assembled.

FIG. 8 is a block diagram of an exemplary reduced-weight aircraft galley refrigeration system including a power supply/conversion module.

### DETAILED DESCRIPTION

A storage compartment cooling apparatus may be coupled with a storage compartment and direct a cool gas, e.g. air, into or around an exterior of the storage compartment through one or more ducts. In this way, the storage compartment cooling apparatus may cool an interior of the storage compartment and thereby contents of the storage compartment. In various embodiments, the SCCA as described herein may be configured to have a reduced weight and/or space utilization compared to an SCCA of the prior art. For aircraft designed for longer commercial passenger flights or larger passenger capacity, a larger number of galleys and SCCA's are typically installed onboard the aircraft. Consequently, the weight and/or space utilization of the embodiments described herein may result in significant savings compared to SCCA's of the prior art in these aircraft.

In various embodiments, the SCCA may be configured to function as part of a storage compartment cooling system onboard an aircraft. The storage compartment cooling system may include a central liquid coolant distribution system configured to circulate the liquid coolant to multiple SCCA's onboard the aircraft. The central liquid coolant distribution system may include a compressor and a condenser configured to cool the liquid coolant. The compressor and condenser may be part of a central chilling system located away from the galleys onboard the aircraft. Because the compressor and condenser are included in the central liquid coolant distribution system, SCCA's which are designed to utilize the central liquid coolant distribution system as part of the storage compartment cooling system onboard the aircraft may not need to include dedicated compressors and condensers. Instead, the SCCA's may use the liquid coolant provided by the central liquid coolant distribution system to generate cool air to cool the storage compartment. Consequently, weight and space utilization of embodiments of the SCCA's described herein may be reduced compared to an SCCA of the prior art which includes a compressor and a condenser as part of a self-contained vapor cycle system.

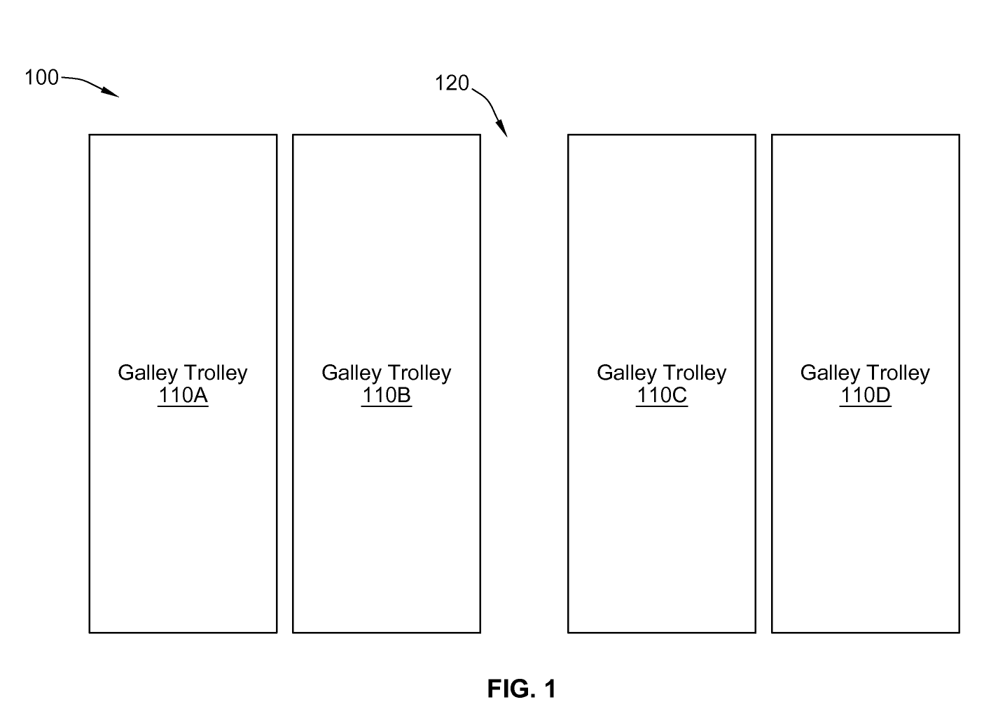

FIG. 1 illustrates a front view of an exemplary arrangement of galley trolleys in a lower portion of an aircraft galley 100. As illustrated, the lower portion of the aircraft galley 100 may include more than one galley trolley, such as galley trolleys 110A, 110B, 110C, and 110D. Hereinafter, any one or more of galley trolleys 110A, 110B, 110C, and 110D may be referred to simply as galley trolley 110. Aircraft galleys which include more than one galley trolley 110 may include a service column 120, which may also be referred to as a galley center console. The service column 120 may include galley infrastructure components (e.g., piping and wiring) to support the galley trolleys 110 and/or other equipment installed in the aircraft galley, e.g. a microwave oven (not shown). Each galley trolley 110 may include a handle on the front of the galley trolley 110 and/or wheels on the bottom of the galley trolley 110 (not shown) to facilitate installation and removal of the galley trolley 110 from the lower portion of the aircraft galley 100.

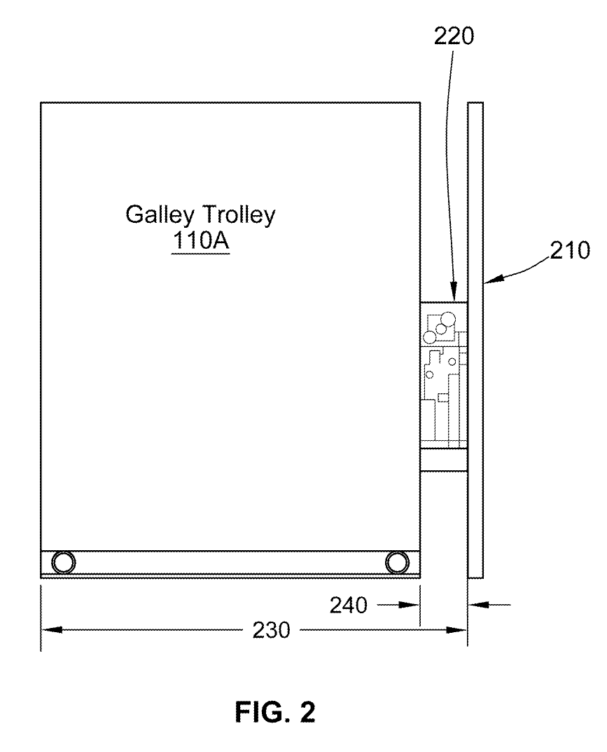

FIG. 2 illustrates a side view of an exemplary refrigerated galley trolley 110A including an SCCA 220 installed at the rear of the galley trolley 110A. The galley's total depth 230 may be fixed, while an embodiment of a galley trolley (such as the galley trolley 110A) may have a depth which depends upon a function of the galley trolley and any supporting equipment which may be installed at the rear of the galley trolley.

In various embodiments, the galley's total depth 230 may be between 30 and 40 inches, such as approximately 38 inches. In an example, the total depth of a galley trolley which does not provide refrigeration (not shown) may be virtually as large as the entire galley's total depth 230. However, a depth of the refrigerated galley trolley 110A to which the SCCA 220 is attached may be limited due to a depth 240 of the SCCA 220.

As another example, a galley which is designed to provide refrigeration (e.g., by supporting refrigerated galley trolleys 110), may be designed to have a larger total depth 230 than a galley which is designed to not provide refrigeration. In typical galleys, the depth 240 needed to accommodate SCCA's of the prior art (not shown) may be 4 to 5 inches, such as approximately 4.5 inches, or more. These 4 to 5 inches needed to accommodate the SCCA's of the prior art are consequently not available for passenger seating.

To maximize space available for passenger seating, the galley's total depth 230 may be desired to be minimized while also maximizing a depth of the refrigerated galley trolley 110A, and consequently a storage capacity of the refrigerated galley trolley 110A. The SCCA 220 may be designed in accordance with the embodiments described herein to minimize the depth 240 of the SCCA 220 to achieve the goal of minimizing the galley's total depth 230 while also maximizing the depth of the refrigerated galley trolley 110A. For example, the SCCA 220 may be designed to have a depth 240 of less than 4 inches, for example approximately 3.5 inches or less.

To the rear of the galley trolley 110A may be a wall 210. The wall 210 may include a rear wall of the galley. The wall 210 may also include wall insulation configured to provide noise suppression properties to minimize an amount of noise from the SCCA 220 heard in a passenger cabin of the aircraft. Wall insulation may also be included in a wall panel attached against the wall 210, or between the wall 210 and the SCCA 220. The wall insulation may also reduce or prevent condensation from the SCCA 220 from reaching the wall 210 or forming on the wall 210 due to operation of the SCCA 220. By minimizing the depth 240 of the SCCA 220, the wall insulation may be attached against the wall 210 when not practical in conjunction with SCCA's of the prior art. Additionally, a thicker wall insulation may be attached against the wall 210 than may be possible in the prior art. In galleys utilizing SCCA's of the prior art (not shown) which have a larger depth 240 than the SCCA 220, wall insulation externally attached to the wall 210 may be removed to facilitate the required depth of the SCCA's of the prior art while maximizing the space available for passenger seating. Therefore, the SCCA 220 may enable quieter refrigeration systems in aircraft galleys than SCCA's of the prior art.

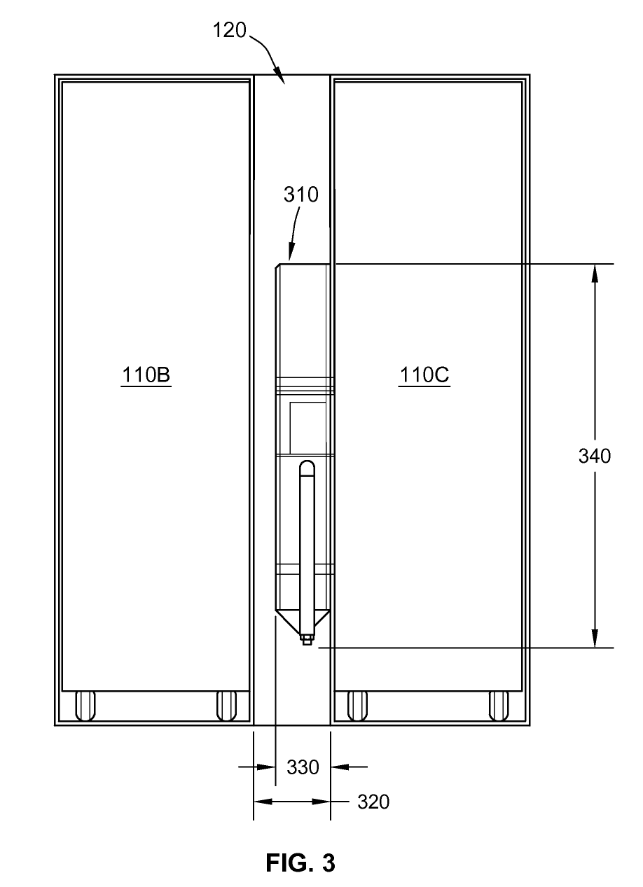

FIG. 3 illustrates an exemplary installation of an SCCA 310 at a side of a galley trolley 110C in a service column 120 between galley trolleys 110B and 110C. The SCCA 310 may include the SCCA 220 described with reference to FIG. 2. The SCCA may have a height 340 which is less than a height of the galley trolleys 110. For example, the SCCA may have a height 340 between approximately 20 and 30 inches, such as approximately 24 inches. In some embodiments, the service column 120 may have a width 320 of approximately five inches. The SCCA 310 may have a depth 330 which is less than the width 320 of the service column 120. In some embodiments, the depth 330 may be approximately equal to the depth 240 illustrated in FIG. 2. For example, the depth 330 may be 4.5 inches, 4.0 inches, 3.5 inches, or less.

By installing the SCCA 310 at the side of the galley trolley 110C in the service column 120, a depth of the galley trolley 110C may be maximized because the rear of the galley trolley 110C may be able to be closer to the back wall of the galley without the SCCA 310 therebetween. In some embodiments, ducts (not shown) may route air between the SCCA 310 and the rear of the galley trolley 110C. In various embodiments, a distance between the rear of the galley trolley 110C illustrated in FIG. 3 and the rear wall of the aircraft galley may be at least 2 to 3 inches less than a distance between the rear of the galley trolley 110A illustrated in FIG. 2 and the rear wall of the aircraft galley.

In various embodiments, an SCCA (e.g., the SCCA 220 or SCCA 310) may be installed at a top or at a bottom of a galley trolley such as the galley trolley 110A. Because the SCCA may be thinner than in the prior art, locations separate from the galley trolley (e.g., above and below the galley trolley), which may have been unsuitable for installation of a storage compartment cooling apparatus of the prior art due to space constraints, may be suitable to installation of embodiments of the SCCA as described herein. For example, an embodiment of the SCCA may be installed below a floor panel upon which the galley trolley rests. As another example, another embodiment of the SCCA may be installed under a work deck of the galley above the galley trolley. As a third example, yet another embodiment of the SCCA may be installed above the galley in which the galley trolley is located. A duct system may be installed between the SCCA at any location at which the SCCA is installed and the storage compartment of the galley trolley to route cool air from the SCCA to the storage compartment.

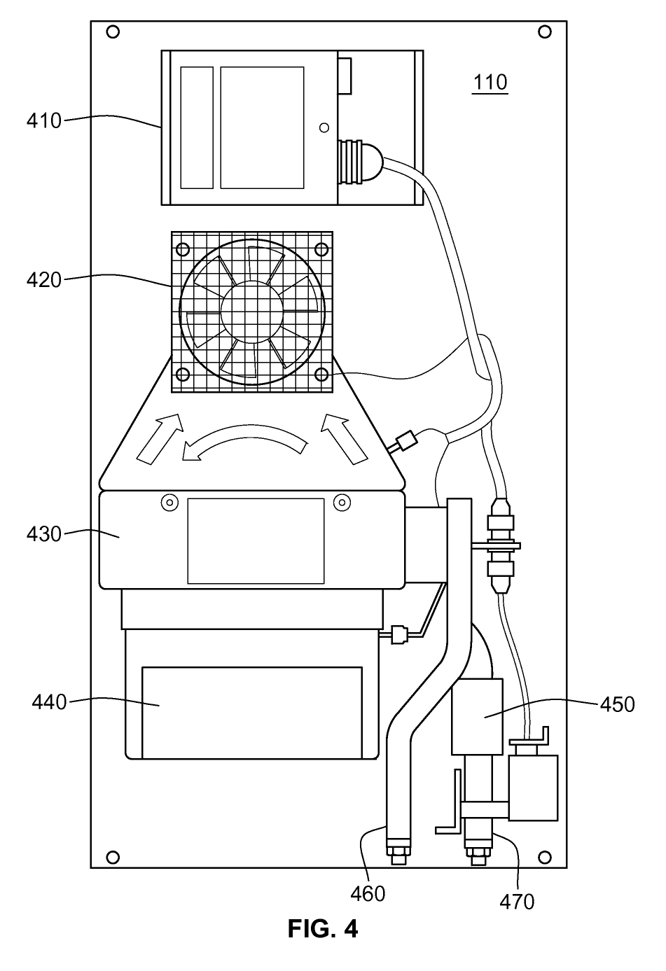

FIG. 4 is a diagram of an exemplary SCCA installed at the rear of a galley trolley 110. The SCCA illustrated in FIG. 4 may include a liquid chilled mini galley air cooler configured to function as part of a storage compartment cooling system onboard an aircraft. The liquid chilled mini galley air cooler illustrated in FIG. 4 may include size-reduced components compared to an SCCA of the prior art. The size-reduced components may contribute toward the liquid chilled mini galley air cooler having a smaller depth than a prior art SCCA. For example, the liquid chilled mini galley air cooler may have a depth of approximately 3.5 inches or less. Additionally, the size-reduced components may contribute toward the liquid chilled mini galley air cooler having a lower weight than a prior art SCCA.

The liquid chilled mini galley air cooler may include a control/power electronics (E-box) 410, a fan 420, and a liquid circulation system configured to circulate a liquid coolant having a temperature lower than an ambient temperature. The liquid circulation system may include a heat exchanger 430, a liquid coolant control valve 450, a supply liquid coolant conduit 470, and a return liquid coolant conduit 460. The liquid chilled mini galley air cooler may also include an air duct assembly 440 configured to supply air to the heat exchanger 430. The air duct assembly 440 may collect air supplied to the heat exchanger 430 from the vicinity of the liquid chilled mini galley air cooler.

The E-box 410 may be electrically coupled with the fan 420, the heat exchanger 430, the air duct assembly 440, and/or the liquid coolant control valve 450 via one or more wires or cables. The E-box 410 may control the liquid chilled mini galley air cooler to maintain a temperature of an interior of the galley trolley 110 at an approximately constant set temperature.

The E-box 410 may also couple with a data bus or network onboard the aircraft for communication with a central computer system or controller. Accordingly, the central computer system or controller may control the liquid chilled mini galley air cooler via a data connection with the E-box 410 over the data bus or network. For example, the E-box 410 may include a node of a power management data bus network. Exemplary power management data bus networks include ARINC 812 power management functionality. The E-box 410 may also include an integral part of a Supplemental Cooling System's CAN Bus network as well as a CAN Bus node member on an ARINC 812 Galley Data Bus (GDB). The E-box 410 and/or the central computer system or controller may include a processor and a memory. The processor may be configured to execute instructions to perform a method of controlling the liquid chilled mini galley air cooler. The instructions may be stored on a computer-readable storage medium, such as a compact disc, flash memory, random access memory (RAM), read-only memory (ROM), or other computer-readable storage medium as known in the art.

The fan 420 may include an elongated fan, an axial flow fan, a radial flow fan, or a centrifugal fan. The fan 420 may be configured to cause air to flow through the heat exchanger 430 and out through the fan 420. The fan 420 may be coupled with ducts (not shown) to direct the flow of the air from the heat exchanger 430 through the fan and into the galley trolley 110. In embodiments where the fan 420 includes an axial flow fan, the fan 420 may receive and output air in a direction approximately parallel with an axis of rotation of blades of the fan 420. In embodiments where the fan 420 includes a radial flow fan, the fan 420 may receive and output air in a direction approximately perpendicular with an axis of rotation of blades of the fan 420. In embodiments where the fan 420 includes a centrifugal fan, the fan 420 may receive air in a direction approximately parallel with an axis of rotation of blades of the fan 420 and output air in a direction approximately perpendicular with the axis of rotation of blades of the fan 420.

Depth of the liquid chilled mini galley air cooler may be driven, at least in part, by the design of the fan 420. In particular, the air flow direction and the air flow rate of the fan 420 may determine a width of the fan 420, which in turn may determine a minimum depth of the liquid chilled mini galley air cooler which includes the fan 420. For example, SCCA's of the prior art which utilize an axial flow fan may have a minimum depth of approximately 4.5 inches, whereas embodiments of the liquid chilled mini galley air cooler described herein utilizing a radial flow fan or a centrifugal fan may have a minimum depth of approximately 3.5 inches or less.

The liquid circulation system may be configured to use a liquid coolant, having a temperature lower than an ambient air temperature, supplied by the central liquid coolant distribution system to cool the air which flows through the heat exchanger 430. The cooled air may be used by the liquid chilled mini galley air cooler to cool the storage compartment. The liquid circulation system may receive the liquid coolant via the supply liquid coolant conduit 470. The coolant control valve 450 may control a flow of the liquid coolant according to a control signal (e.g., an electrical signal) received from the E-box 410. The liquid coolant may circulate through the heat exchanger 430. The heat exchanger 430 may cool the air which flows through the heat exchanger 430 through a process in which heat energy from the air is absorbed by the liquid coolant in the heat exchanger 430, resulting in cooled air output from the heat exchanger 430 which is cooler than the air input into the heat exchanger 430. The liquid coolant output from the heat exchanger 430 may then be output to the central liquid coolant distribution system through the return liquid conduit 460. In alternative embodiments (not shown), the liquid chilled mini galley air cooler may include a self-contained vapor cycle system rather than couple with the central liquid coolant distribution system.

The cooled air output from the heat exchanger 430 may then be directed to a storage compartment of the galley trolley 110 using a cooled air duct assembly (not shown) which receives the cooled air from the fan 420. In some embodiments, the cooled air duct assembly may direct the cooled air into the storage compartment of the galley trolley 110. In alternative embodiments, the cooled air duct assembly may direct the cooled air exterior to and alongside an interior wall of the storage compartment.

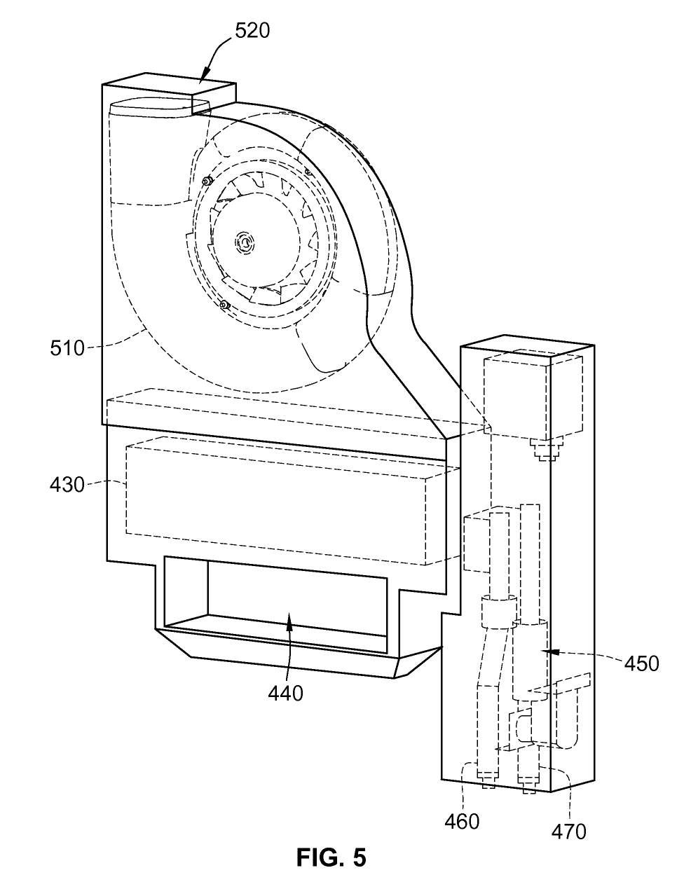

FIG. 5 illustrates an exemplary SCCA comprising a centrifugal fan 510. The exemplary SCCA illustrated in FIG. 5 operates in a manner similar to that described with reference to FIG. 4, with the exception of the centrifugal fan 510. The centrifugal fan 510 may be configured to input air from a direction parallel with a rotational axis of the centrifugal fan 510. The centrifugal fan 510 may include a housing assembly 520 configured to direct the air from the air duct assembly 440 through the heat exchanger 430 and then into the centrifugal fan 510. The housing assembly 520 may then direct the air output from the centrifugal fan 510 in a direction perpendicular to the axis of rotation of the centrifugal fan 520. A cooled air duct assembly (not shown) may couple with the housing assembly 520 to route the cooled air output from the centrifugal fan 510 to a storage compartment (not shown) to cool the storage compartment.

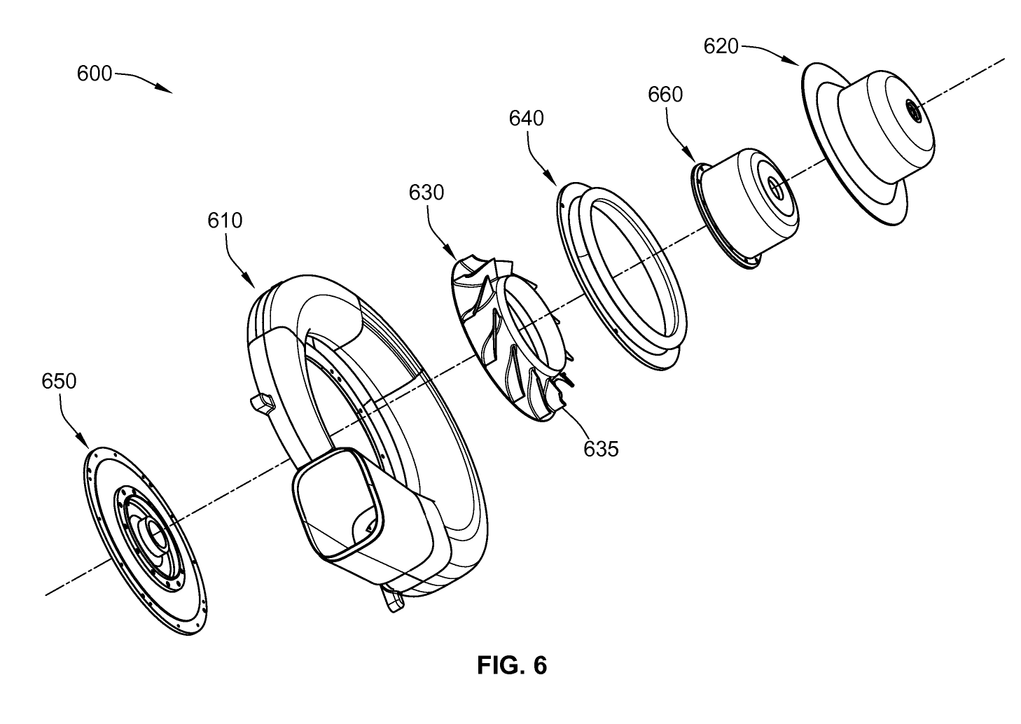

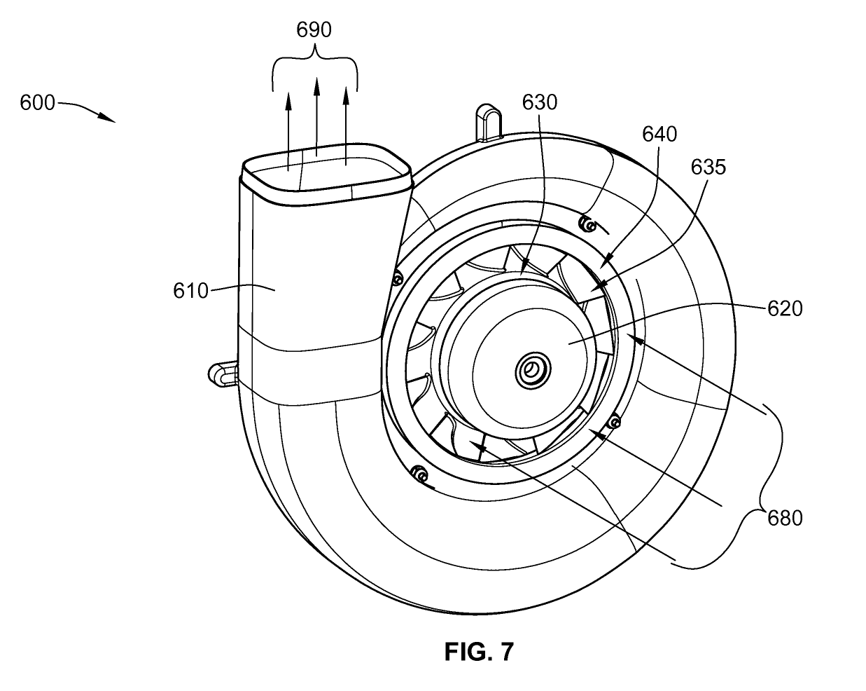

FIG. 6 is a perspective view of components of an exemplary centrifugal fan 600, and FIG. 7 is a perspective view of the exemplary centrifugal fan 600 assembled. The exemplary centrifugal fan 600 includes a volute 610, an impeller 630, a plurality of fan blades 635 coupled with the impeller 630, a stator 640, a bell cap 660, a base plate 650, and a housing 620. The impeller 630 may rotate such that the plurality of fan blades 635 cause air flow 680 to come into the centrifugal fan from a direction approximately parallel with an axis of rotation of the impeller 630. The volute 610 may then output an air flow 690. The volute 610 may be configured to control the volume and/or pressure of the output air flow 690.

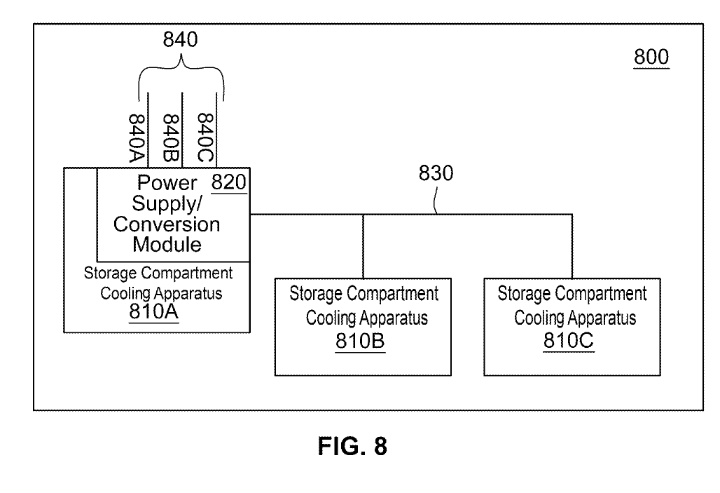

FIG. 8 is a block diagram of an exemplary reduced-weight aircraft galley refrigeration system 800 including a power supply/conversion module 820. The aircraft galley refrigeration system 800 includes an storage compartment cooling apparatus (SCCA) 810A, an SCCA 810B, and an SCCA 810C (collectively referred to as the SCCA's 810). In various embodiments, the aircraft galley refrigeration system 800 may include more or fewer SCCA's. The SCCA's 810A, 810B, and 810C may be referred to as a “galley group triplet” when installed proximate to one another in a common galley area. The power supply/conversion module 820 may be integral or unitary with the SCCA 810A.

The power supply/conversion module 820 may be configured to couple with a variable frequency (e.g., “wild” frequency) alternating current (AC) power bus 840 having three phases, phase 840A, phase 840B, and phase 840C. The power supply/conversion module 820 may be configured to receive power from the power bus 840 over wires or cables, and process or condition the power. For example, the power supply/conversion module 820 may include electronic and/or electrical components configured to convert the AC three phase power into an approximately constant voltage direct current (DC) power. In other embodiments, the power supply/conversion module 820 may be configured to perform DC voltage conversion. The processing or conversion performed by the power supply/conversion module 820 may depend upon the voltage and frequency of the power provided by the power bus 840 as well as the required input voltage and frequency of the SCCA's 810. The power supply/conversion module 820 may then distribute the conditioned power 830 to the SCCA's 810A, 810B, and 810C over wires or cables.

The three phases 840A, 840B, and 840C of the power bus 840 may be generated aboard an aircraft by generators coupled with the aircraft's engines. The three phases 840A, 840B, and 840C may have “wild” frequency, or a frequency which varies depending on a rotational rate (i.e., revolutions per minute or RPM) of the engines with which the generators are coupled. The power supply/conversion module 820 may convert the wild frequency power from the power bus 840 into 270 volt DC power output to the SCCA's 810.

The power supply/conversion module 820 may couple with the power bus 840 and/or the SCCA's 810 using a connector or port installed on a housing of the power supply/conversion module 820. A wire or cable may couple at one end with the connector or port on the power supply/conversion module 820 using a complementary-shaped connector. The wire or cable may then couple at an opposite end with the power bus 840 and/or the SCCA's 810 using a connector configured to connect thereto.

The SCCA's 810 may have reduced weight compared to SCCA's of the prior art, because the power supply/conversion module 820 is shared among the SCCA's 810 rather than each SCCA 810 having a dedicated power supply/conversion module. The power supply/conversion module 820 may be separate and distinct from the SCCA's 810. For example, a weight of each of the SCCA's 810 may be approximately 8.3 kg, and a weight of the power supply/conversion module 820 may be approximately 0.8 kg. Therefore, a combined weight of the SCCA's 810A, 810B, 810C, and the power supply/conversion module 820 may be approximately 25.7 kg. If each SCCA 810 included its own power supply/conversion module 820, a combined weight may be approximately 27.3 kg. Therefore, sharing the power supply/conversion module 820 among the SCCA's 810 may provide approximately 1.6 kg, or 5.9%, weight savings. Furthermore, a combined weight of a triplet of prior art SCCA's may be approximately 30 kg. Therefore, the combined weight of the SCCA's 810 and the power supply/conversion module 820 as illustrated in FIG. 8 may be approximately 4.3 kg, or approximately 14.3% less, compared with a triplet of prior art SCCA's.

In another embodiment, the power supply/conversion module 820 may be integral with and incorporated into the SCCA 810A. The SCCA 810A may then be considered a “power provider” SCCA. The SCCA 810A may use the power supply/conversion module 820 to provide power for itself, and then distribute or provide power to the SCCA's 810B and 810C via a local distributed power bus. The SCCA's 810B and 810C may be considered “power consumer” SCCA's. For logistical purposes relating to maintenance of aircraft utilizing the SCCA's 810, such as convenience of ordering and storage of spare parts, having the SCCA's 810A, 810B, and 810C substantially similar to one another and having the power supply/conversion module 820 configured as a separate LRU may be preferred. For example, the SCCA's 810A, 810B, and 810C may all share a same part number. As another example, a part number may be assigned for a kit which includes a single power supply/conversion module 820 and several (e.g., two, three, four, or more) SCCA 810's. The SCCA 810's included in the kit may be configurable as either “power provider” or “power consumer” SCCA's.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. While the embodiments discussed herein have been discussed in the context of aircraft systems, it will be appreciated that these embodiments may be applied to other vehicles such as spacecraft, ships, trains, automobiles, trucks, and buses. It will be recognized that the terms “comprising,” “including,” and “having,” as used herein, are specifically intended to be read as open-ended terms of art.

What is claimed is:

1. A storage compartment cooling apparatus comprising:
a liquid circulation system configured to circulate a liquid coolant having a temperature lower than an ambient temperature;
a centrifugal fan configured to cause a gas to flow in contact with the liquid circulation system and thereby cool the gas, the centrifugal fan configured to receive the gas from a direction approximately parallel with an axis of rotation of the fan and output the gas to a direction approximately perpendicular with the axis of rotation of the fan; and
a duct configured to direct the gas into contact with the liquid circulation system and through the centrifugal fan.

2. The storage compartment cooling apparatus of claim 1, wherein the gas includes air.

3. The storage compartment cooling apparatus of claim 1, wherein a maximum depth of the storage compartment cooling apparatus is less than 4.5 inches.

4. The storage compartment cooling apparatus of claim 1, wherein a maximum depth of the storage compartment cooling apparatus is less than 4.0 inches.

5. The storage compartment cooling apparatus of claim 1, wherein the liquid circulation system comprises a heat exchanger.

6. A storage compartment cooling system, comprising:
a storage compartment cooling apparatus comprising
a liquid circulation system configured to circulate a liquid coolant having a temperature lower than an ambient temperature;
a centrifugal fan configured to cause a gas to flow in contact with the liquid circulation system and thereby cool the gas, the centrifugal fan configured to receive the gas from a direction approximately parallel with an axis of rotation of the fan and output the gas to a direction approximately perpendicular with the axis of rotation of the fan; and
a duct configured to direct the gas into contact with the liquid circulation system and through the centrifugal fan; and
a storage compartment to which the storage compartment cooling apparatus is installed.

7. The storage compartment cooling system of claim 6, wherein the storage compartment cooling apparatus is installed at a rear of the storage compartment.

8. The storage compartment cooling system of claim 6, wherein the storage compartment cooling apparatus is installed at a side of the storage compartment.

9. The storage compartment cooling system of claim 6, wherein the storage compartment cooling apparatus is installed at a top of the storage compartment.

10. The storage compartment cooling system of claim 6, wherein the storage compartment cooling apparatus is installed at a bottom of the storage compartment.

11. The storage compartment cooling system of claim 6, wherein the storage compartment cooling apparatus is installed under a galley work deck above the storage compartment.

12. The storage compartment cooling system of claim 6, wherein the storage compartment cooling apparatus is installed under a floor panel below the storage compartment.

13. The storage compartment cooling system of claim 6, wherein the storage compartment cooling apparatus is installed above a galley in which the storage compartment is located.

14. A storage compartment cooling system comprising:
a plurality of storage compartment cooling apparatuses, each of the plurality of storage compartment cooling apparatuses coupled with a storage compartment and configured to cool an interior of the storage compartment, each of the plurality of storage compartment cooling apparatuses comprising:
a liquid circulation system configured to circulate a liquid coolant having a temperature lower than an ambient temperature;
a centrifugal fan configured to cause a gas to flow in contact with the liquid circulation system and thereby cool the gas, the centrifugal fan configured to receive the gas from a direction approximately parallel with an axis of rotation of the fan and output the gas to a direction approximately perpendicular with the axis of rotation of the fan; and
a duct configured to direct the gas into contact with the liquid circulation system and through the centrifugal fan; and
the storage compartment cooling system further comprising:
a central liquid coolant distribution system configured to circulate the liquid coolant to the plurality of storage compartment cooling apparatuses.

15. The storage compartment cooling system of claim 14, wherein the gas includes air.

16. The storage compartment cooling system of claim 14, wherein the plurality of storage compartment cooling apparatuses further comprise an output duct configured to direct the cooled gas into the storage compartment.

17. The storage compartment cooling system of claim 14, wherein the plurality of storage compartment cooling apparatuses further comprise an output duct configured to direct the cooled gas exterior to and alongside an interior wall of the storage compartment.

18. The storage compartment cooling system of claim 14, wherein a maximum depth of the plurality of storage compartment cooling apparatuses is less than 4.5 inches.

19. The storage compartment cooling system of claim 14, wherein a maximum depth of the plurality of storage compartment cooling apparatuses is less than 4.0 inches.

20. The storage compartment cooling system of claim 14, wherein at least one of the plurality of storage compartment cooling apparatuses is installed at a side of the storage compartment between the storage compartment and an adjacent storage compartment.

21. The storage compartment cooling system of claim 14, wherein at least one of the plurality of storage compartment cooling apparatuses is installed at a rear of the storage compartment.

22. The storage compartment cooling system of claim 14, wherein at least one of the plurality of storage compartment cooling apparatuses is installed at a top of the storage compartment.

23. The storage compartment cooling system of claim 14, wherein at least one of the plurality of storage compartment cooling apparatuses is installed at a bottom of the storage compartment.

24. The storage compartment cooling system of claim 14, wherein at least one of the plurality of storage compartment cooling apparatuses is installed under a galley work deck above the storage compartment.

25. The storage compartment cooling system of claim 14, wherein at least one of the plurality of storage compartment cooling apparatuses is installed above a galley in which the storage compartment is located.

26. The storage compartment cooling system of claim 14, wherein at least one of the plurality of storage compartment cooling apparatuses is installed under a floor panel below the storage compartment.

27. A storage compartment cooling system comprising:
a plurality of storage compartment cooling apparatuses, each of the plurality of storage compartment cooling apparatuses coupled with a storage compartment and configured to cool an interior of the storage compartment, each of the plurality of storage compartment cooling apparatuses comprising:
a liquid circulation system configured to circulate a liquid coolant having a temperature lower than an ambient temperature;
a fan configured to cause a gas to flow in contact with the liquid circulation system and thereby cool the gas;
a duct configured to direct the gas into contact with the liquid circulation system and through the centrifugal fan; and
the storage compartment cooling system further comprising:
a power distribution module configured to receive power from a power bus, condition the power, and distribute the conditioned power to the plurality of storage compartment cooling apparatuses.

28. The storage compartment cooling system of claim 27, wherein the power distribution module's conditioning of the power comprises converting variable frequency alternating current power received from the power bus into direct current power for distribution to the plurality of storage compartment cooling apparatuses.

29. The storage compartment cooling system of claim 27, wherein the power distribution module is integrated with one of the plurality of storage compartment cooling apparatuses.

30. The storage compartment cooling system of claim 27, wherein the plurality of storage compartment cooling apparatuses comprise a node of a power management data bus network.
